(19) United States
(12) Patent Application Publication
(10) Pub. No.: US 2019/0109815 A1
(43) Pub. Date: Apr. 11, 2019

(54) METHOD AND APPARATUS FOR DISCOVERING AN IP ADDRESS FOR AN ANONYMOUS GEO-SYNCHRONIZED NODE

(71) Applicant: QUALCOMM Incorporated, San Diego, CA (US)

(72) Inventors: Amar Kumar NANDAN, Hyderabad (IN); Kihak YI, Hyderabad (IN); Abhigyan JOSHI, Hyderabad (IN); Nitin MEHROTRA, Hyderabad (IN); Venkata A Naidu BABBADI, Hyderabad (IN)

(21) Appl. No.: 15/730,012

(22) Filed: Oct. 11, 2017

(51) Int. Cl. H04L 29/12; G01S 5/00; H04W 8/26

(52) U.S. Cl. CPC H04L 61/2084; G01S 5/0018; H04L 67/18; H04W 8/26; H04L 61/2007

(57) ABSTRACT

An IP address for a resource node may be discovered. In a method, a first client receives an IP address request. The IP address request includes destination geographical location information associated with the resource node. The first determines whether the destination geographical location information is within a geographical coverage area of the first client. The first client forwards the IP address request to a next client that is geographically closer to the resource node based on the destination geographical location information if the destination geographical location information is not within the geographical coverage area of the first client.

### BACKGROUND

### Field

The present invention relates generally to resolving a reachable internet protocol (IP) address for a destination node in a network using geographical location information.

### Background

Current IP address resolution generally requires a centralized service such as a domain name system (DNS) which may use a centralized server that is always available. However, a network, such as an ad hoc network, may not lend itself to the use of a centralized service. Further, in a network that includes mobile devices, a mobile device may move in and out of a communication range of other devices, thus limiting the availability and stability of connections and services.

There is therefore a need for techniques for resolving a reachable IP address for a device providing services and resources.

### SUMMARY

An aspect of the present invention may reside in a method for discovering an IP address for a resource node. In the method, a first client receives an IP address request. The IP address request includes destination geographical location information associated with the resource node. The first client may determine whether the destination geographical location information is within a geographical coverage area of the first client. The first client may forward the IP address request to a next client that is geographically closer to the resource node based on the destination geographical location information if the destination geographical location information is not within the geographical coverage area of the first client.

In more detailed aspects of the invention, the IP address request may be received from a source node, and the IP address request may further includes source geographical location information of the source node. Also, the resource node may comprise a mobile station, the first client may comprise a mobile station, and the next client may comprise a mobile station. The IP address request may include a service type parameter, and may include a service duration parameter.

In other more detailed aspects of the invention, a first group of geo-synchronized clients may include the first client, and a second group of geo-synchronized clients may include the next client. The first group may include a first head client for controlling the geo-synchronized clients of the first group, and the second group may include a second head client for controlling the geo-synchronized clients of the second group. The first client may have a first identification that includes a geographical location of the first client, and the next client may have a second identification that includes a geographical location of the next client. The first identification may further include a geographical coverage of the first client, and the second identification may further include a geographical coverage of the next client. The source node, the resource node, the first client, and the next client, may be in a ad hoc network.

Another aspect of the invention may reside in an apparatus for discovering an IP address for a resource node, comprising: means for receiving an IP address request, wherein the IP address request includes destination geographical location information associated with the resource node; means for determining whether the destination geographical location information is within a geographical coverage area of the apparatus; and means for forwarding an IP address for the resource node if the destination geographical location information is within the geographical coverage area of the apparatus.

In more detailed aspects of the invention, the IP address request may originate at a source node, and the IP address request may further include source geographical location information of the source node. Also, the resource node may comprise a mobile station, and the apparatus may comprise a mobile station. The IP address request may be received from a client.

Another aspect of the invention may reside in an apparatus for discovering an IP address for a resource node, comprising: a processor configured to: forward an IP address request for the resource node to a client, wherein the IP address request includes source geographical location information of the apparatus and includes destination geographical location information associated with the resource node, and wherein the client is geographically closer to the resource node based on the source geographical location information and the destination geographical location information; and receive an IP address for the resource node in response to the IP address request.

In other more detailed aspects of the invention, the processor may be further configured to communicate with the resource node using the IP address for the resource node.

Another aspect of the invention may reside in a computer-readable medium, comprising: code for causing a computer to receive an IP address request, wherein the IP address request includes destination geographical location information associated with a resource node; code for causing the computer to determine whether the destination geographical location information is within a geographical coverage area of the computer; and code for causing the computer to forward the IP address request to a next client that is geographically closer to the resource node based on the destination geographical location information if the destination geographical location information is not within the geographical coverage area of the computer.

### BRIEF DESCRIPTION OF THE DRAWINGS

FIG. 1 is a schematic diagram of coverage areas of client groups.

FIG. 2 is a flow diagram of methods for discovering an IP address for a resource node, according to the present invention.

FIG. 3 is a flow diagram of a method for discovering an IP address for a resource node, according to the present invention.

FIG. 4 is a schematic diagram of a protocol header.

FIG. 5 is a flow diagram of another method for discovering an IP address for a resource node.

FIG. 6 is a flow diagram of another method for discovering an IP address for a resource node.

FIG. 7 is a block diagram of a computer including a processor and a memory.

FIG. 8 is flow diagram of an overview of the operation of a system supporting IP address discovery.

FIG. 9 is flow diagram of client initiation.

FIG. 10 is flow diagram of client/group formation.

FIG. 11 is flow diagram of an client head change.

FIG. 12 is flow diagram of group communication, and maintenance of neighboring group information.

FIG. 13 is a flow diagram of a response to a query.

### DETAILED DESCRIPTION

The word “exemplary” is used herein to mean “serving as an example, instance, or illustration.” Any embodiment described herein as “exemplary” is not necessarily to be construed as preferred or advantageous over other embodiments.

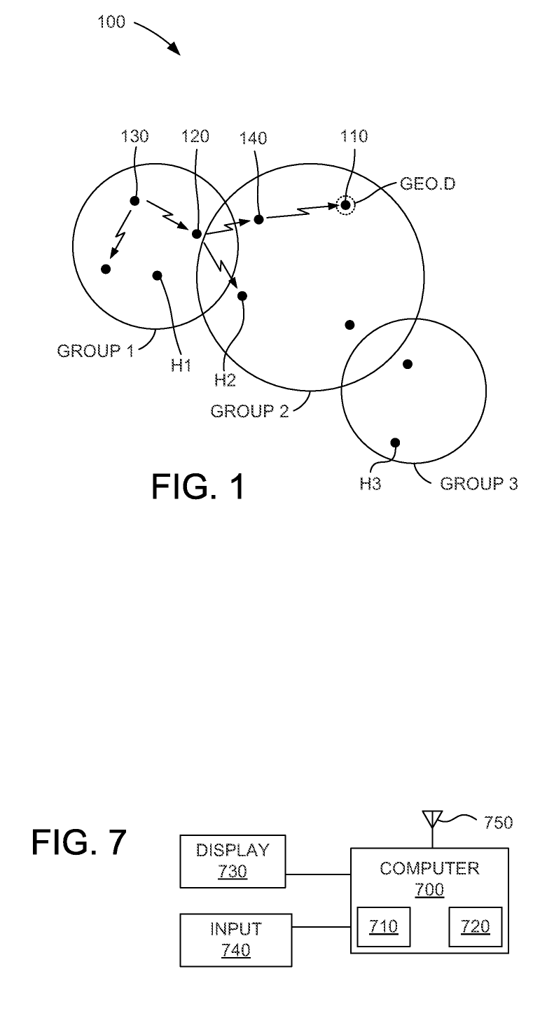

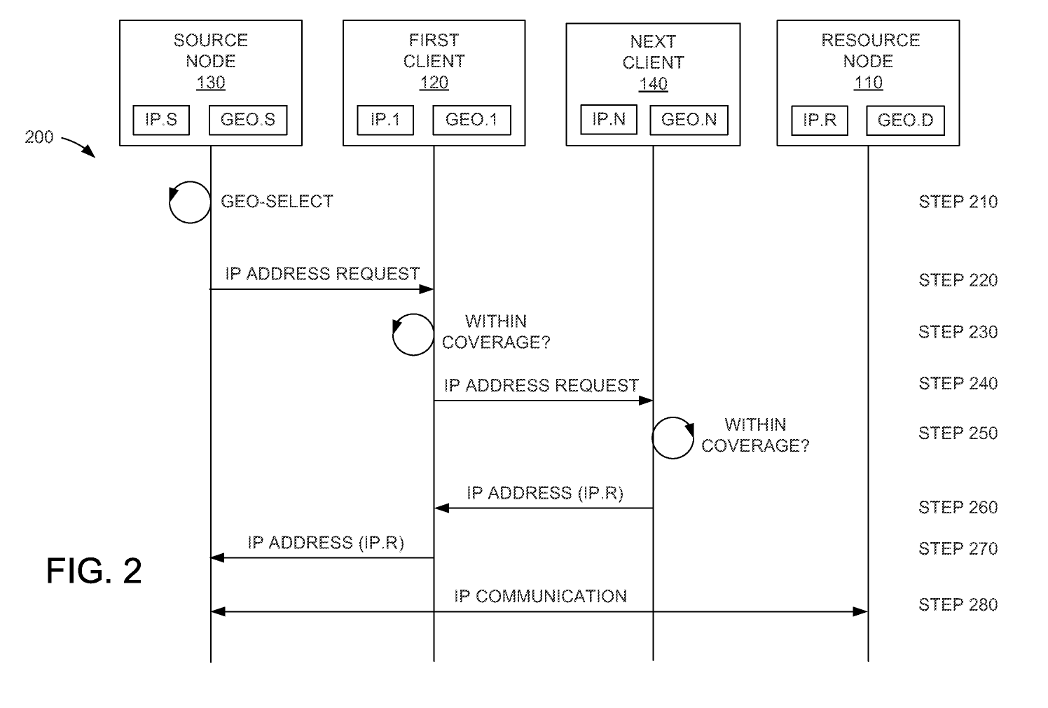

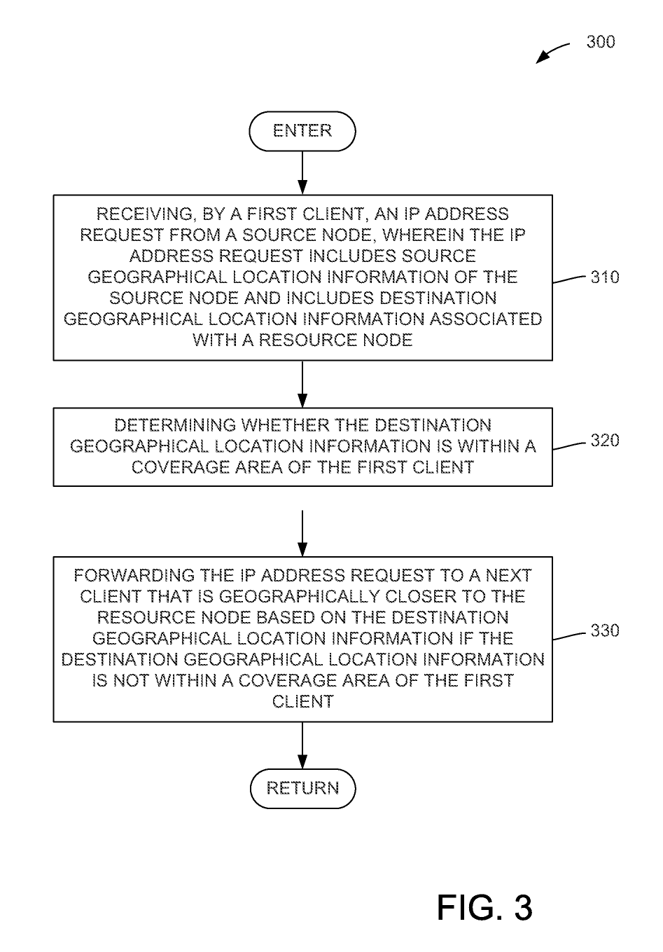

With reference to FIGS. 1-3, an aspect of the present invention may reside in a method 300 for discovering an IP address (IP.R) for a resource node 110. In the method, a first client 120 may receive an IP address request from a source node 130 (step 220/310). The IP address request may include destination geographical location information (GEO.D) associated with the resource node 110, and may include source geographical location information (GEO.S) of the source node 130. The first client may determine whether the destination geographical location information is within a geographical coverage area of the first client (step 230/320). The first client may forward the IP address request to a next client 140 that is geographically closer to the resource node based on the destination geographical location information if the destination geographical location information is not within the geographical coverage area of the first client (step 240/330).

In more detailed aspects of the invention, the resource node 110 may comprise a mobile station, the first client 120 may comprise another mobile station, and the next client 140 may comprise yet another mobile station. The IP address request may include a service type parameter, and includes a service duration parameter.

In other more detailed aspects of the invention, a first group (Group 1) of geo-synchronized clients may include the first client 120, and a second group (Group 2) of geo-synchronized clients may include the next client 140. The first group may include a first head client H1 for controlling the geo-synchronized clients of the first group, and the second group may include a second head client H2 for controlling the geo-synchronized clients of the second group. The first client may have a first identification (ClientID.1) that includes a geographical location (GEO.1) of the first client, and the next client may have a second identification (ClientID.2) that includes a geographical location (GEO.N) of the next client. The first identification may further include a geographical coverage of the first client, and the second identification may further include a geographical coverage of the next client. The source node, the resource node, the first client, and the next client, may be in a ad hoc network.

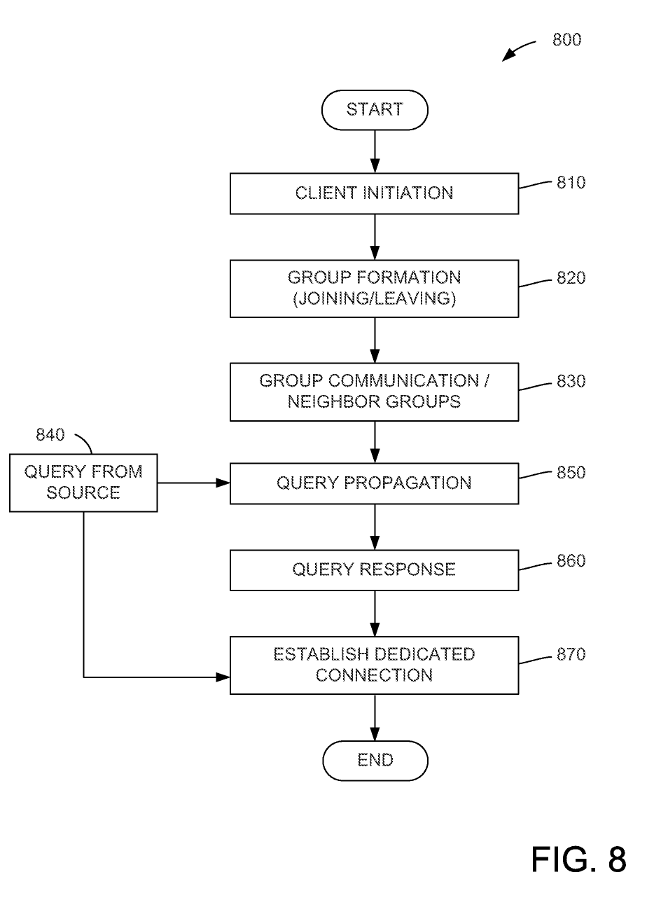

With reference to FIG. 7, a client, source node and/or resource node may be a mobile station which may comprise a computer 700 that includes a processor 710, a storage medium 720 such as memory and/or a disk drive, a display 730, and an input such as a keypad 740, and a wireless connection 750.

Another aspect of the invention may reside in a computer-readable medium 720, comprising: code for causing a computer 700 to receive an IP address request, wherein the IP address request includes destination geographical location information (GEO.D) associated with a resource node 110; code for causing the computer to determine whether the destination geographical location information is within a geographical coverage area of the computer; and code for causing the computer to forward the IP address request to a next client 140 that is geographically closer to the resource node based on the destination geographical location information (GEO.D) if the destination geographical location information is not within the geographical coverage area of the computer.

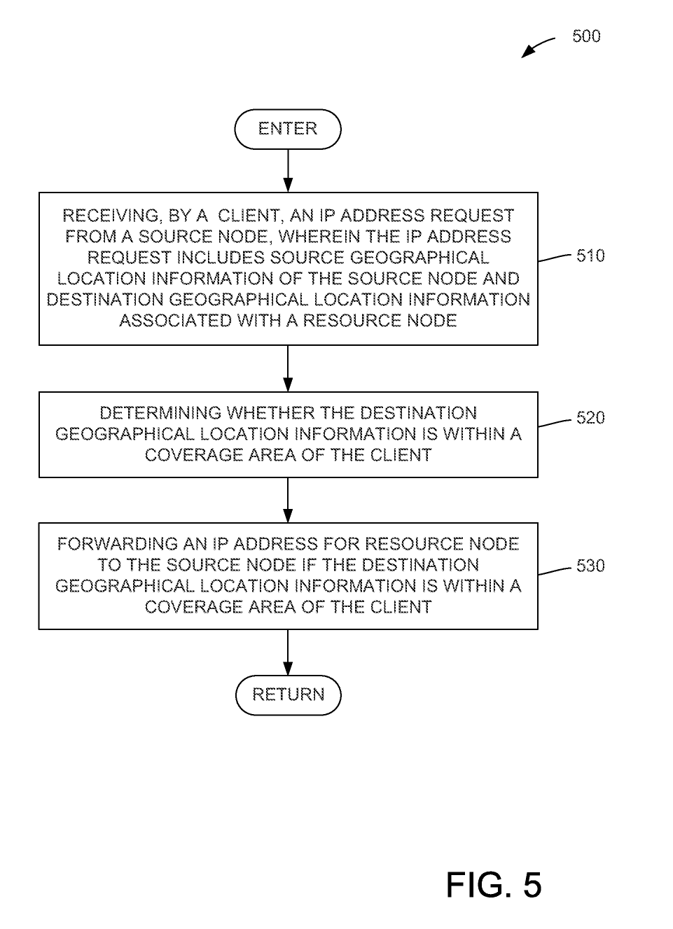

With further reference to FIG. 5, another aspect of the invention may reside in a method 500 for discovering an IP address (IP.R) for a resource node 110, comprising: receiving, by a client 120, an IP address request from a source node 130 (step 220/510), wherein the IP address request includes destination geographical location information (GEO.D) associated with the resource node 110 and source geographical location information (GEO.S) of the source node 130; determining, by the client 120, whether the destination geographical location information (GEO.D) is within a geographical coverage area (Group 1) of the client 120 (step 230/520); and forwarding, by the client 120, an IP address (IP.R) for the resource node 110 to the source node 130 if the destination geographical location information (GEO.D) is within a geographical coverage area (Group 1) of the client 120 (step(s) 260 and 270/530).

Another aspect of the invention may reside in an apparatus (e.g., client 120) for discovering an IP address for a resource node 110, comprising: means (e.g., processor 700) for receiving an IP address request, wherein the IP address request includes destination geographical location information (GEO.D) associated with the resource node 110; means (e.g., processor 700) for determining whether the destination geographical location information is within a geographical coverage area of the apparatus; and means (e.g., processor 700) for forwarding an IP address (IP.R) for the resource node if the destination geographical location information is within the geographical coverage area of the apparatus.

In more detailed aspects of the invention, the resource node 110 may comprise a mobile station, and the apparatus may comprise a mobile station. The IP address request may be received from another client. The ad hoc network may be an overlay network and may evolve without requiring a central server/fixed centralized infrastructure. The underlying network may be a cellular or similar network that provides IP-based communications.

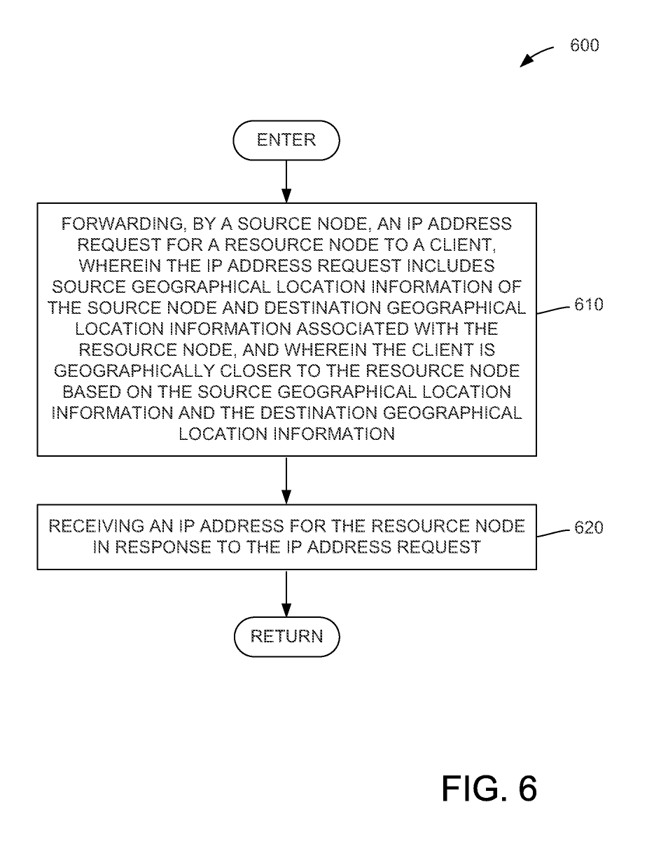

With further reference to FIG. 6, another aspect of the invention may reside in method 600 for discovering an IP address (IP.R) for a resource node 110, comprising: forwarding, by a source node 130, an IP address request for the resource node 110 to a client 120, wherein the IP address request includes source geographical location information (GEO.S) of the source node 130 and destination geographical location information (GEO.D) associated with the resource node 110, and wherein the client 120 is geographically closer to the resource node 110 based on the source geographical location information (GEO.S) and the destination geographical location information (GEO.D) (steps 210 and 220/610); and receiving, by the source node 130, an IP address (IP.R) for the resource node 110 in response to the IP address request (step 270/620).

In other more detailed aspects of the invention, the source node 130 may communicate with the resource node 110 using the IP address (IP.R) for the resource node (step 280).

Another aspect of the invention may reside in an apparatus (e.g., source node 130) for discovering an IP address for a resource node 110, comprising: a processor 700 configured to: forward an IP address request, for the resource node 110, to a client 120, wherein the IP address request includes source geographical location information (GEO.S) of the apparatus and includes destination geographical location information (GEO.D) associated with the resource node, and wherein the client is geographically closer to the resource node based on the source geographical location information and the destination geographical location information; and receive an IP address (IP.R) for the resource node in response to the IP address request.

FIG. 8 shows an overview of the operation of a system supporting IP address discovery. First, the client may be initiated (element 810), and the group may be formed with provisions for joining/leaving nodes (element 820). Communications may be between nodes, and information on neighboring groups is maintained (element 830). The query for the IP address (and port) may be generated by a source node (element 840). The query may be propagated by clients until the IP address of the destination node having the desired resource is discovered. The query may be propagated to neighboring clients using vector propagation, map matching, or a jump method (element 850). A query response may be returned by a client having a coverage area that includes the destination node (element 860). The query response may include a reachable IP address and port number. The query source node and the destination node are then able to establish a dedicated/secure connection (element 870). The nodes may then negotiate and start services/resources.

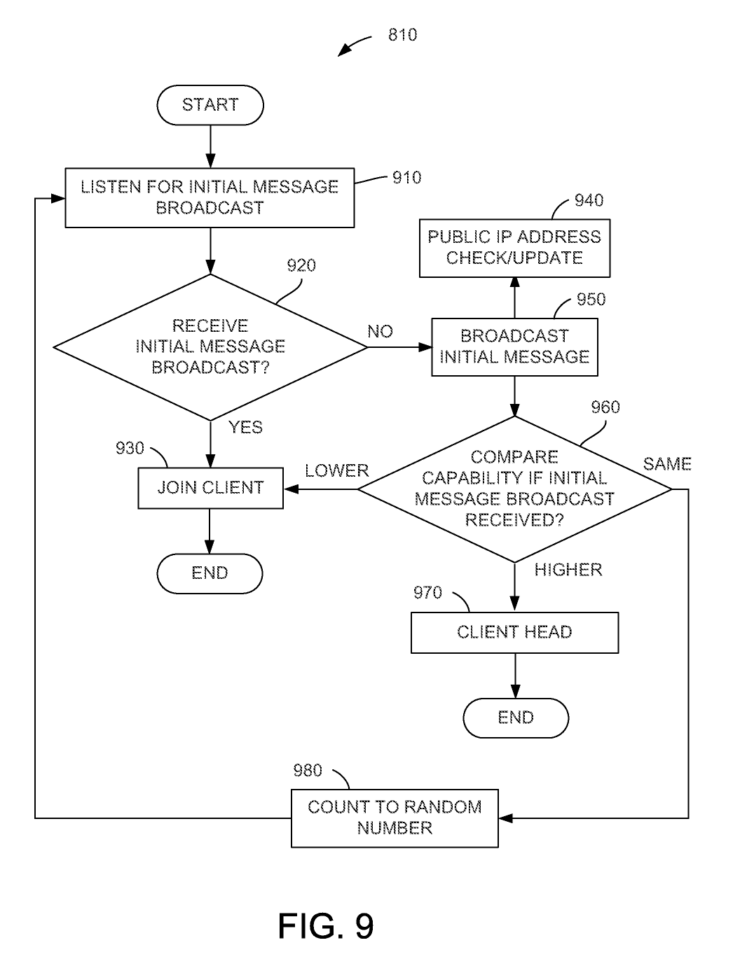

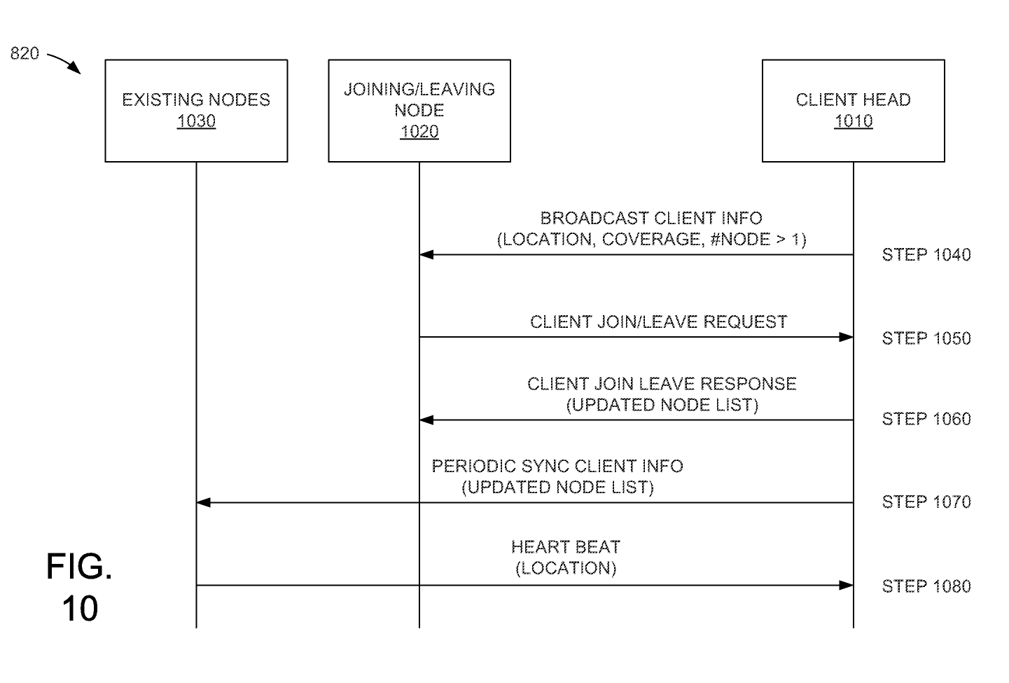

FIG. 9 shows a flow diagram for client initiation 810. The initiation starts by listening for an initial message broadcast (step 910). If an initial message broadcast is received (step 920), the node joins the client (step 930), and the initiation ends. If an initial message broadcast is not received, the node broadcasts an initial message (step 950). The node also checks if a public IP address is available, and updates the public IP address, if available (step 940). If not available, the node broadcasts a whoami message. If an initial message broadcast is received from another node, the node compares its capability with the other node (step 960). If the node's capability is lower than that of the other node, the node joins the existing client (step 930), and the initiation ends. If the node's capability is the same as that of the other node, the node generates a random number and counts to that number (step 980). After counting to the random number, the node returns to listening for an initial message broadcast (step 910). If the node's capability is higher, it becomes the client head (step 970), and the client initiation ends.

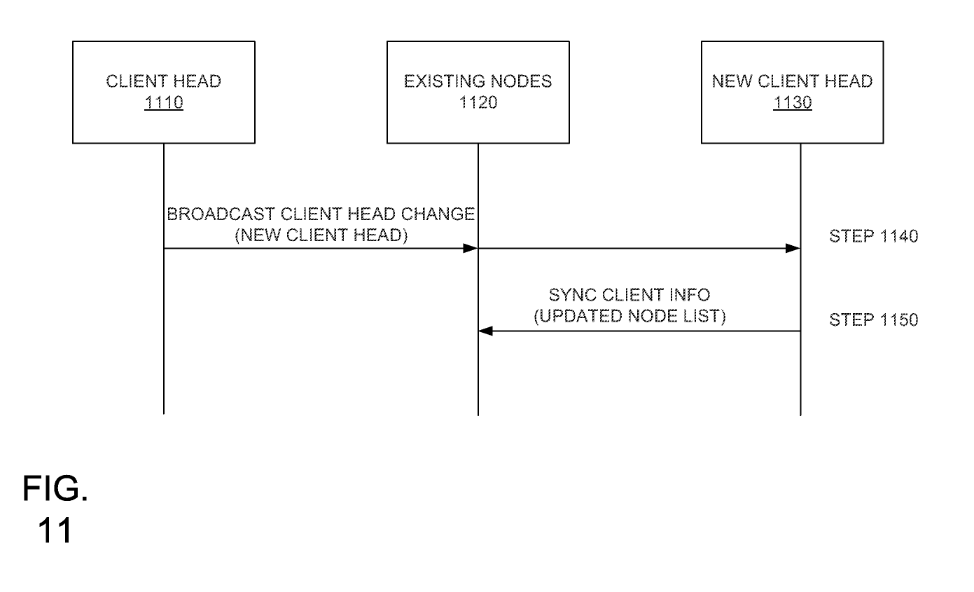

FIG. 10 shows client/group formation 820. A joining/leaving node 1020 receives broadcasted client information from a client head 1010 (step 1040). The broadcasted client information may include geographical location, coverage, and a count of the number of nodes (total nodes—1). The joining/leaving node sends a request to the client head (step 1050). The client head sends a response to the requesting node, and includes an updated node's list in the case of a joining node (step 1060). A periodic synchronization message is sent to existing nodes 1030, and includes an updated node list having client information (step 1070). The existing nodes send “heartbeat” messages to the client head, which messages include geographical location information.

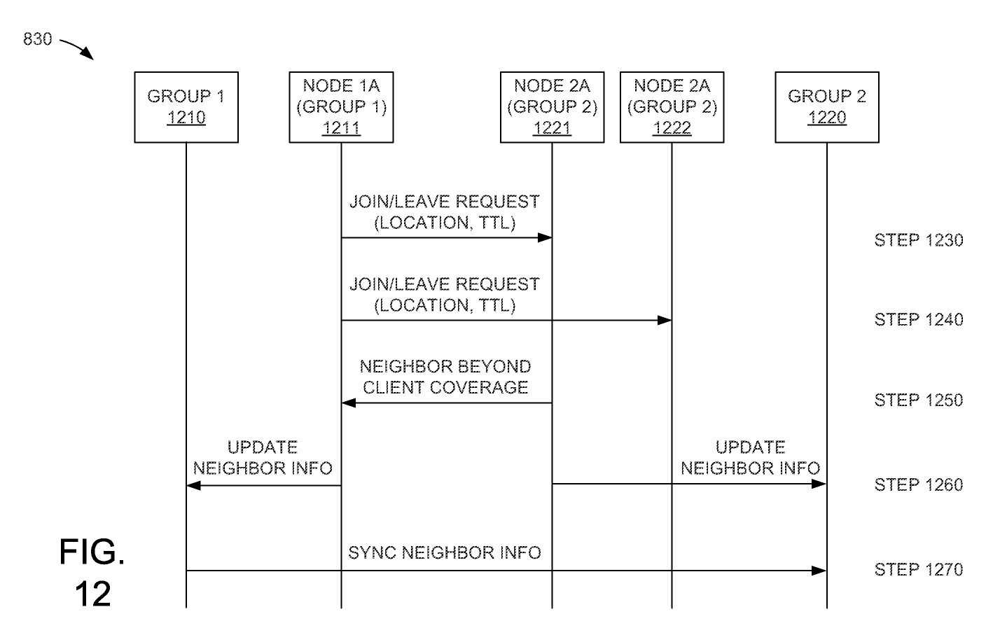

FIG. 11 show a client head change. The existing client head 1110 broadcasts a client head change message, which includes information on the new client head 1130 (step 1140). The existing nodes 1120 receive an updated node list from the new client head in an synchronize client information message (step 1150).

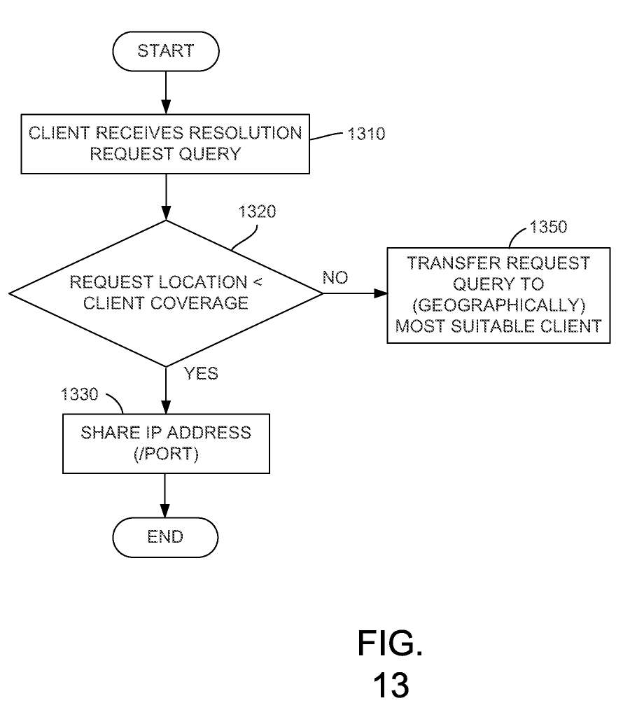

FIG. 12 shows group communication, and maintenance of neighboring group information 830. A node 1211 in a first group (Group 1) may send a join/leave request which is received by nodes, 1221 and 1222, of a second group (Group 2) (steps 1230 and 1240). A node 1221 of the second group may send a reply message indicating that it is a neighbor beyond the client coverage of the first group. The node 1211 in the first group may send a message updating neighbor information to a client head 1210 of the first group, and the node in the second group may send a message updating neighbor information to a client head 1220 of the second group (step 1260). The groups may synchronize neighbor information (step 1270)

FIG. 13 shows a response to a query. A client receives a resolution request query (step 1310). The client determines whether the location in the request is within the client's coverage area (step 1320). If yes, the client shares the destination IP address and port number of the target resource node (step 1330), and the client's response to the query ends. Is not, the client transfers the request query to the geographically most suitable client (step 1350), as discussed herein.

Emerging use cases generally require a true direct terminated internet protocol (IP) connection. Such uses include vehicle-to-vehicle (V2V)/vehicle-to-everything (V2X) communications, internet of things (IOT), electronic/mobile (e/m) commerce, ad hoc sensor networks, and remote resource sharing and control. Social networks generally need a contact number or profile identification (ID) for mobile originated IP resolution. Generally there is no existing practical technical for IP resolution/direct IP connection to an anonymous mobile node at a given destination, without using a centralized service such as DNS or a location-based services (LBS) directory and/or server. The present invention allows resolution of a publicly reachable IP address/port number for an anonymous mobile node at a given destination using the node's geographical location, without using a permanent centralized service. Accordingly, the present invention permits a device to resolve the IP address between anonymous geo-synchronized nodes (AGSNs). In the present context, anonymous may mean other node not knowing certain identity information for the node such as Mobile Directory Number (MDN), Subscriber Identification Module (SIM) credentials, Uniform Resource Locator (URL), Facebook ID, etc.

A defined AGSN client enables geographically spread nodes to access a geo-location by providing a reachable IP address:port of a node within a vicinity anonymously. The AGSN client forms a group of node within a geographical vicinity or coverage area. These nodes anonymously share attributes of each other using location information as an identification. This enables geo-synchronized IP resolution without a centralized server. A source will broadcast an AGSN client query with a geographical location of a destination of interest. The broadcasted AGSN client query will be relayed toward the final destination vicinity of a IP network by an AGNS protocol. At least one node in the final destination vicinity responds with its reachable IP address:port anonymously. The source can establish a secure session directly with the destination IP address:port, and access the requested service/information.

An AGSN client may comprise of a few nodes which may collaborate with other nodes and other AGSN clients. When a new node joins, or an existing node leaves, an AGSN client (or AGSN head client) may update this information for all connected nodes/AGSN clients. An AGSN client head may be a node itself, and may be designated by another node, such as a leaving existing AGSN client head.

An AGSN client may have the following attributes: location information such as latitude (lt) and longitude (lg), number of participating nodes, size/coverage of the AGSN client in terms of location information (lt1-lt2, lg1-lg2), route information, type (what is the size of the object/destination, e.g., small, big, large, etc.); capability, e.g., duration of service (such as 12 hours), video/audio/temperature, rf (3CA 4G, WiFi, WiMAX), computing power, battery status; and AGSN client ID (derived/calculated or previously stored). All nodes in an AGSN client may have the same AGSN client ID as the AGSN client (AGSN client head).

The AGSN client may be defined by a 38 digit integer based on location information and coverage. For example, the latitude and longitude may follow a format of PDegreeMinutesSecond format (PDDDMMSS.SS) where P is plus or minus. The resolution may be 1 foot. The coverage latitude and longitude (Clt, Clg) may be calculated from lt1-lt2 and lg1-lg2. The maximum coverage (F) may depend on the AGSN client head type. Thus, the AGSN client ID may be ltlgCltClg. The AGSN client ID may change on the addition or attrition of nodes. All nodes in an AGSN client have the same AGSN client ID.

As an example, an AGSN client may have a latitude of +17′ 23″ 46.26, and a longitude of +26′ 78″ 56.15. The AGSN client would begin with the following 19 digits: +017234626+26785615. For 12 participating nodes, the coverage would be based on the longitude and latitude to the nodes in the AGSN client, e.g.: lt1-lt12 and lg1-lg12, based on the most distance between the nodes.

An AGSN client may have the following storage format: Node (ith) information such as local IP address:port, public IP address:port, capability, and location (latitude/longitude); neighbor AGSN client identification; AGSN client identification (lt:PDDDMMSS.SS lg:PDDMMSS.SS Clt:PDDDMMSS.SS Clg:PDDMMSS.SS); number of nodes, next AGSN client head (most suitable node), and AGSN client head mark (such as 1 for AGSN client head).

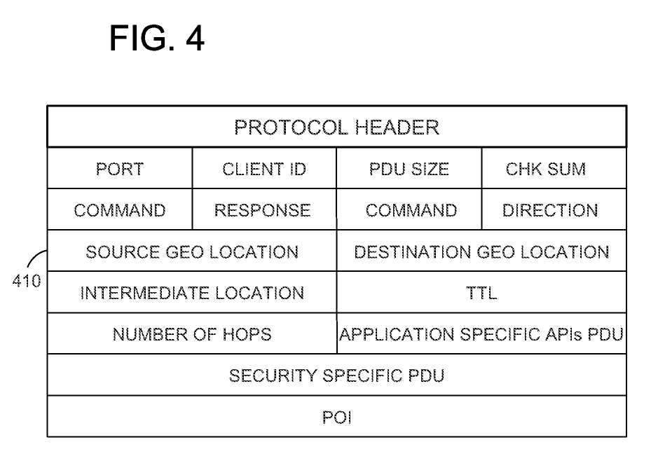

An example of a header 410 for an AGSN protocol is shown in FIG. 4. The header may include port number (PORT), AGSN client ID, protocol data unit (PDU) size, check sum, command, response, command, direction, source geographical location, destination geographical location, intermediate location, time-to-live (TTL), number of hops, application specific APIs PDU, security specific PDU, and POI.

A typical wireless mobile station may include a handheld phone, or a laptop computer. The wireless communication system may employ any one of a number of multiple access techniques such as code division multiple access (CDMA), time division multiple access (TDMA), frequency division multiple access (FDMA), space division multiple access (SDMA), polarization division multiple access (PDMA), or other modulation techniques known in the art.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary embodiments, the functions described may be implemented in hardware, software, firmware, or any combination thereof. If implemented in software as a computer program product, the functions may be stored on or transmitted over as one or more instructions or code on a computer-readable medium. Computer-readable media includes both non-transitory computer-readable storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A method for discovering an IP address for a resource node, comprising:
receiving, by a first client, an IP address request, wherein the IP address request includes destination geographical location information associated with the resource node;
determining, by the first client, whether the destination geographical location information is within a geographical coverage area of the first client; and
forwarding, by the first client, the IP address request to a next client that is geographically closer to the resource node based on the destination geographical location information if the destination geographical location information is not within the geographical coverage area of the first client.

2. The method of claim 1, wherein:
the IP address request is received from a source node; and
the IP address request further includes source geographical location information of the source node.

3. The method of claim 2, wherein the source node, the resource node, the first client, and the next client, are in a ad hoc network.

4. The method of claim 1, wherein the resource node comprises a mobile station.

5. The method of claim 4, wherein:
the first client comprises a mobile station; and
the next client comprises a mobile station.

6. The method of claim 1, wherein the IP address request includes a service type parameter, and includes a service duration parameter.

7. The method of claim 1, further comprising:
a first group of geo-synchronized clients including the first client; and
a second group of geo-synchronized clients including the next client.

8. The method of claim 7, wherein:
the first group includes a first head client for controlling the geo-synchronized clients of the first group; and
the second group includes a second head client for controlling the geo-synchronized clients of the second group.

9. The method of claim 1, wherein:
the first client has a first identification that includes a geographical location of the first client; and
the next client has a second identification that includes a geographical location of the next client.

10. The method of claim 9, wherein:
the first identification further include a geographical coverage of the first client; and
the second identification further includes a geographical coverage of the next client.

11. An apparatus for discovering an IP address for a resource node, comprising:
means for receiving an IP address request, wherein the IP address request includes destination geographical location information associated with the resource node;
means for determining whether the destination geographical location information is within a geographical coverage area of the apparatus; and
means for forwarding an IP address for the resource node if the destination geographical location information is within the geographical coverage area of the apparatus.

12. The apparatus of claim 11, wherein:
the IP address request originates at a source node; and
the IP address request further includes source geographical location information of the source node.

13. The apparatus of claim 12, wherein:
the resource node comprises a mobile station; and
the apparatus comprises a mobile station.

14. The apparatus of claim 12, wherein the IP address request is received from a client.

15. The apparatus of claim 12, wherein the IP address request is received from the source node.

16. The apparatus of claim 12, wherein:
the source node has a first identification that includes a geographical location of the source node; and
the apparatus has a second identification that includes a geographical location of the apparatus.

17. The apparatus of claim 16, wherein:
the first identification further include a geographical coverage of the source node; and
the second identification further includes a geographical coverage of the apparatus.

18. An apparatus for discovering an IP address for a resource node, comprising:
a processor configured to:
forward an IP address request for the resource node to a client, wherein the IP address request includes source geographical location information of the apparatus and includes destination geographical location information associated with the resource node, and wherein the client is geographically closer to the resource node based on the source geographical location information and the destination geographical location information; and
receive an IP address for the resource node in response to the IP address request.

19. The apparatus of claim 18, wherein the resource node comprises a mobile station.

20. The apparatus of claim 19, wherein:
the apparatus comprises a mobile station; and
the client comprises a mobile station.

21. The apparatus of claim 18, wherein the IP address request includes a service type parameter, and includes a service duration parameter.

22. The apparatus of claim 18, wherein:
the apparatus has a first identification that includes a geographical location of the apparatus; and
the client has a second identification that includes a geographical location of the client.

23. The apparatus of claim 22, wherein:
the first identification further include a geographical coverage of the apparatus; and
the second identification further includes a geographical coverage of the client.

24. The apparatus of claim 18, wherein the processor is further configured to:
communicate with the resource node using the IP address for the resource node.

25. A computer-readable medium, comprising:
code for causing a computer to receive an IP address request, wherein the IP address request includes destination geographical location information associated with a resource node;
code for causing the computer to determine whether the destination geographical location information is within a geographical coverage area of the computer; and
code for causing the computer to forward the IP address request to a next client that is geographically closer to the resource node based on the destination geographical location information if the destination geographical location information is not within the geographical coverage area of the computer.

26. The computer-readable medium of claim 25, wherein:
the IP address request is received from a source node; and
the IP address request further includes source geographical location information of the source node.

27. The computer-readable medium of claim 25, wherein the resource node comprises a mobile station.

28. The computer-readable medium of claim 27, wherein:
the computer comprises a mobile station; and
the next client comprises a mobile station.

29. The computer-readable medium of claim 25, wherein:
the computer has a first identification that includes a geographical location of the computer; and
the next client has a second identification that includes a geographical location of the next client.

30. The computer-readable medium of claim 29, wherein:
the first identification further include a geographical coverage of the computer; and
the second identification further includes a geographical coverage of the next client.
